(19) United States
(12) Patent Application Publication
(10) Pub. No.: US 2023/0034181 A1
(43) Pub. Date: Feb. 2, 2023

(54) BOTANICAL LIGHTING SYSTEM AND METHOD OF OPERATION

(71) Applicant: Botanical Lighting Systems, L.L.C., Milford, MI (US)

(72) Inventors: Shane DuFresne, Auburn, MI (US); Larry Quigg, Milford, MI (US)

(21) Appl. No.: 17/878,543

(22) Filed: Aug. 1, 2022

Related U.S. Application Data
(60) Provisional application No. 63/228,281, filed on Aug. 2, 2021.

(51) Int. Cl. A01G 7/04; F21V 21/16; G01C 3/08

(52) U.S. Cl. CPC A01G 7/045; F21V 21/16; G01C 3/08

(57) ABSTRACT

A height-adjustable botanical lighting system and a method of operating the same. The height-adjustable botanical lighting system comprises a height adjustment assembly, one or more light assemblies, and one or more sensors. The light assemblies depend from the height adjustment assembly. The sensors are adjustably coupled to the light assemblies. The sensors cause the height adjustment assembly to raise the light assemblies in response to one or more generally upward advancing plants interfering with a sensor field of the sensors.

### FIELD

The present teachings generally relate to a height-adjustable botanical lighting system and a method of operating the same. The height-adjustable botanical lighting system comprises sensors. The sensors cause the height adjustment assembly to raise the light assemblies in response to one or more generally upward advancing plants interfering with a sensor field of the sensors.

### BACKGROUND

Indoor growing operations typically employ lights to facilitate the growth of plants. The lights provide a light spectrum profile that mimics the light spectrum profile of the sun to facilitate the plant's metabolic processes.

As plants grow in a vertical direction, the canopy of the plants may approach the lights. Some lighting systems may be affixed to a static structure. In these systems the lights are located above the plants at a distance that will not be encroached upon during the life cycle of the plants prior to harvesting. However, during the initial stages of growth, the light is further away from the plant as compared to later stages of growth, where in the later stages of growth the plants approach the light. As a result, the intensity of the light during initial stages of growth is less than the intensity of the light during later stages of growth. This is understood in the context of the inverse square law.

In industrial growth settings, the time it takes to achieve a harvestable plant is crucial. Growers rely upon a predicable time frame from planting to harvest in order to satisfy customer demand. The growing process generally should be as short as possible while also providing a quality product. Growth brevity, as well as quality, typically depends on nutrients and light sources. The light spectrum profile is one important factor in lighting. The provision of consistent intensity of lighting throughout the life cycle of plants, from planting to harvesting is another important factor.

It would be desirable to provide a botanical lighting system that maintains a consistent, pre-determined light intensity to plants throughout their life cycle.

It would be desirable to provide a botanical lighting system that adjusts its height in relation to the vertically advancing height of plants.

It would be desirable to provide a botanical lighting system that adjusts without user input, or at least without user input that does not continue beyond providing initial settings.

It would be desirable to provide a botanical lighting system that adjusts autonomously.

### SUMMARY

The present disclosure relates to a height-adjustable botanical lighting system. The height-adjustable botanical lighting system may address at least some of the needs identified above. The height-adjustable botanical lighting system may comprise a height adjustment assembly, one or more light assemblies, and one or more sensors adjustably coupled to the one or more light assemblies. The one or more light assemblies may depend from the height adjustment assembly. The one or more sensors may autonomously cause the height adjustment assembly to raise the one or more light assemblies in response to one or more generally upward advancing plants interfering with a sensor field of the one or more sensors.

The one or more sensors may be height-adjustable and/or horizontally adjustable relative to the one or more light assemblies. Height adjustment of the one or more sensors may cause the sensor field to be located closer to or further from the one or more light assemblies. Horizontal adjustment of the one or more sensors may cause the sensor field to be located relative to generally upwardly advancing growth paths the one or more plants.

The height-adjustable botanical lighting system may comprise a controller in signal communication with both the one or more sensors and the height adjustment assembly. The controller may be optionally in signal communication with a switching device and/or a computing device. The computing device may be a mobile computing device.

The one or more light assemblies may comprise one or more modular frames and one or more lights. The one or more lights may be coupled to the one or more modular frames. Each of the one or more modular frames may be coupled together edge-to-edge.

The height adjustment assembly may comprise a motor, a drive shaft, optionally a torque transfer member, one or more reels, and one or more suspension members. The drive shaft may be in direct or indirect communication with the motor. The torque transfer member may transfer a torque of the motor, that is in indirect communication with the drive shaft, to the drive shaft. The one or more reels may be coupled to the drive shaft. The one or more suspension members may be adapted to selectively wind and unwind from the one or more reels. The one or more light assemblies may depend from the height adjustment assembly by the one or more suspension members.

The one or more suspension members may include at least two suspension members coupled to or adjacent to opposing edges of each of the one or more light assemblies. Each of the one or more suspension members may be attached at one end to two or more other suspension members that are coupled to or adjacent to opposing edges of each of the one or more light assemblies. The one or more suspension members may be selected from a cable, a wire, a rope, a strap, or a chain.

The torque transfer member may be selected from a roller chain or a belt. The torque transfer member may be a roller chain, and the drive shaft may include a sprocket that engages with the roller chain. The torque transfer member may be a belt, and the drive shaft may include a belt pulley that engages with the belt.

The motor may be a stepper motor or a servo motor.

The one or more sensors may be curtain sensors. The one or more sensors may be mounted about 3 feet or less from one or more lights affixed to the one or more light assemblies.

The present disclosure relates to a method of operating a height-adjustable botanical lighting system. The method may address at least some of the needs identified above. The method may comprise detecting, by a sensor, interference of a sensor field of the sensor by one or more generally upward advancing plants. The method may comprise relaying, by the sensor, a signal to a controller, the signal indicating interference of the sensor field. The method may comprise directing, by the controller, a motor, upon interference of the sensor field, to operate for a pre-determined amount of time or rotate a pre-determined number of rotations and/or fractions thereof. Operation of the motor may cause one or more light assemblies to raise relative to the one or more generally upward advancing plants.

The method may comprise receiving, by the controller, a height parameter. The height parameter may determine the pre-determined amount of time or the pre-determined number of rotations and/or fractions thereof for which the motor operates.

The method may comprise adjusting, by the controller, the height parameter by one or more constants at one or more points in time.

### BRIEF DESCRIPTION OF THE DRAWINGS

FIG. 1 is a perspective view of a height-adjustable botanical lighting system.

FIG. 2 is a plan view of a height-adjustable botanical lighting system.

FIG. 3 is a plan view of a light assembly.

FIG. 4 is a plan view of a height-adjustable botanical lighting system.

FIG. 5 illustrates operation of a sensor.

### DETAILED DESCRIPTION

The present teachings meet one or more of the above needs by the height-adjustable botanical lighting system and method of operating the lighting system described herein.

The present disclosure provides for a botanical lighting system. The botanical lighting system may function to facilitate the growth of plants. The botanical lighting system may provide a supplement for sunlight. The botanical lighting system may provide light radiation in a photosynthetically active region of the electromagnetic spectrum, an ultraviolet region of the electromagnetic spectrum, a far-red region of the electromagnetic spectrum, or any combination thereof. The photosynthetically active region may be from about 400 nm to about 700 nm. The ultraviolet region may be from about 100 nm to about 400 nm. The light radiation may include UV-A, UV-B, or both. The far-red region may be from about 700 nm to about 850 nm.

The plants may be grown indoors. That is, the botanical lighting system may be employed indoors. The plants residing indoors may require artificial lighting to supplement for natural sunlight.

The plants may be grown in a controlled environment. The environment may be controlled for light, temperature, humidity, air flow, nutrient provision, substrate, or any combination thereof. Light, temperature, humidity, air flow, nutrient provision, substrate, or any combination thereof may be referred to herein as environmental parameters. The substrate may be the material in which the plant roots are located. The substrate may be soil, clay, rock, compost, peat moss, recycled biological material (e.g., coconut husk), or any combination thereof. The substrate and roots may be located in a hydroponic environment.

The plants may include edible plants, medicinal plants, or otherwise. The edible plants may have edible leaves, flowers, fruiting bodies (e.g., nuts), seeds, roots, or any combination thereof. The medicinal plants may comprise metabolites and/or secondary metabolites of pharmacological concern. One example of medicinal plants may include cannabis, although any other plants are contemplated by the present teachings. The method and system of the present disclosure may be employed with any type of plant capable of and/or typically grown indoors.

The botanical lighting system may be height adjustable. As the plants grow, they may generally advance in an upward direction. As the plants grow generally upward, the botanical lighting system may height adjust in a generally upward direction. Once plants are harvested and new seeds are planted, the botanical lighting system may height adjust in a generally downward direction to prepare for new growth.

The botanical lighting system may maintain a distance between the canopy of plants during the life cycle of the plants. The distance may be about 6 inches or more 1 foot or more, 2 feet or more, 3 feet or more, or even 4 feet or more. The distance may be about 10 feet or less, 9 feet or less, 8 feet or less, 7 feet or less, or even 6 feet or less. The distance may depend on the particular lights employed, understanding that different lights are manufactured with different intensities.

The distance may be variable during the life cycle of the plants. That is, during a first time period the distance may be different from the distance during a second time period, and so on.

The distance between the botanical lighting system and/or lights installed thereon may increase, decrease, or be maintained throughout the life cycle of the plants.

The distance may be constant during the life cycle of the plants.

Maintaining a distance between the botanical lighting system and/or lights installed thereon and the canopy of the plants may be advantageous to provide a consistent light intensity, provide a pre-determined light intensity in one or more time periods, prevent damage to plants, providing a pre-determined structure to plants, or any combination thereof.

Canopy, as referred to herein, may mean the height of the tallest plant in a sector. Sectors may be defined by the sensing field of sensors, as described herein. By way of example, one or more sensors may cover an 8-foot by 8-foot sector. Thus, the tallest plant within the sector may define the height of the canopy. Typically, plants may grow generally uniformly. However, the present disclosure contemplates that during one or more periods of growth, some plants may have a different height relative to other plants.

Plants may be damaged by drying out and/or burning if the botanical lighting system is too close to the canopy.

Plants may grow shorter and bushier if a light source is located close to the canopy. Plants may grow taller if a light source is located far from the canopy. The distances which may cause these structural characteristics of plants may vary between different plant species and/or controlled environment parameters.

The method and system of the present disclosure may provide for simple and/or autonomous adjustment of distances between the botanical lighting system and/or lights installed thereon and the canopy. At any point during the life cycle of the plants an autonomous adjustment of the botanical lighting system may be overridden by a manual adjustment and/or modified by supplemental settings.

The botanical lighting system of the present disclosure may be modular. That is, individual elements of the botanical lighting system may be duplicated and employed together in any quantity to tailor to different end-uses. For instance, indoor plant growing facilities may have a variety of spatial dimensions. Moreover, floor plans (i.e., locations of plants, walking aisles, equipment, and the like) of indoor plant growing facilities may vary widely. The modular botanical lighting system of the present disclosure may fit within facilities having a variety of spatial dimensions and may be configured to suit a variety of different floor plans.

The botanical lighting system may comprise one or more height adjustment assemblies, light assemblies, controllers, or any combination thereof.

The botanical lighting system may comprise one or more height adjustment assemblies. The height adjustment assembly may function to adjust the height of one or more light assemblies, maintain a distance between one or more light assemblies and a canopy, or both.

The height adjustment assembly may comprise one or more motors, drive shafts, torque transfer members, reels, suspension members, or any combination thereof.

The height adjustment assembly may include one or more motors. The motor may function to generate a torque, rotate one or more drive shafts, cause winding and/or un-winding of one or more suspension members, cause one or more light assemblies to move closer and/or further away from plants, or any combination thereof.

The motor may generate torque. The torque may be applied to one or more drive shafts. The torque may cause one or more drive shafts to rotate. Rotation of a drive shaft may cause winding and/or unwinding of suspension members.

The motor may directly cause one or more drive shafts to rotate. The motor may be directly coupled to one or more drive shafts. A rotor of the motor may be directly coupled to one or more drive shafts. A rotor of the motor may be coupled to an end of one or more drive shafts. A shaft of the motor may be directly coupled to both a rotor of the motor, at one end, and a drive shaft, at another end. A rotational axis of a rotor may be co-axial with the rotational axis of the drive shaft.

The motor may indirectly cause one or more drive shafts to rotate. The motor may be indirectly coupled to one or more drive shafts. The motor may be indirectly coupled to one or more drive shafts via one or more torque transfer members. By way of example, a motor may cause movement of a roller chain and the roller chain may engage with a sprocket of a drive shaft to cause the same to rotate. A rotational axis of a rotor of a motor may be parallel to the rotational axis of the drive shaft.

The motor may be a bi-directional motor. That is, the motor may be capable of rotating in a clockwise and/or counterclockwise direction.

The motor may be AC or DC powered. The motor may brushed, brushless, synchronous, or asynchronous. The motor may be a stepper motor or a servo motor.

One motor may be suitable for a drive shaft length, whether a single drive shaft or multiple drive shafts affixed together, of about 36 feet or less, 32 feet or less, 18 feet or less, or even 14 feet or less.

The height adjustment assembly may comprise one or more drive shafts. The drive shaft may function to translate movement between a motor and one or more reels, cause winding or un-winding of suspension members, or both.

The drive shaft may be a generally elongate member. The drive shaft may be generally cylindrical and/or tubular. The drive shaft may include two opposing ends. A first end may be coupled to a motor or free. A second end may be free.

The drive shaft may rotate in a first angular direction to wind suspension members. The drive shaft may rotate in a second angular direction to un-wind suspension members. The angular direction may be clockwise or counter-clockwise.

The height adjustment assembly may comprise one or more torque transfer members. The torque transfer member may function to transfer torque generated by a motor to a drive shaft, reels, or both.

The torque transfer member may be coupled to both a motor and one or more drive shafts. The torque transfer member may extend between a motor and one or more drive shafts. The motor and drive shaft may have rotational axes that are in parallel.

The torque transfer member may be flexible. The torque transfer member may be elastic. The torque transfer member may be fabricated from polymer, metal, or both.

The torque transfer member may be fabricated from linked segments. The linked segments may include a chain, or the like. An exemplary chain may include a roller chain, although any other types of chains are contemplated by the present teachings. The torque transfer member may be fabricated from a continuous material. The continuous member may include a band, a belt, the like, or any combination thereof.

The torque transfer member may be a roller chain, and the drive shaft may include a sprocket that engages the roller chain. The motor may cause the roller chain to rotate the sprocket. Rotation of the sprocket may cause the drive shaft to rotate.

The torque transfer member may be a belt, and the drive shaft may include a belt pulley that engages the belt. The motor may cause the belt to rotate the belt pulley. Rotation of the belt pulley may cause the drive shaft to rotate.

The height adjustment assembly may comprise one or more reels. The reel may function to wind and unwind suspension members. One or more reels may be disposed along the length of a drive shaft. Rotation of the drive shaft may rotate the reels. Torque generated by a motor may be translated to reels via a torque transfer member, a drive shaft, or both.

The reels may be structurally discrete from a drive shaft. The reels may be coupled to the drive shaft. By way of example, reels may be slid onto the drive shaft and fastened thereto via one or more mechanical and/or chemical fasteners.

The reels may be integrally formed in a drive shaft. By way of example, grooves may be molded or machined into a drive shaft.

The reels may be removably fixed in place along the length of a drive shaft. The reels may be translatable along a drive shaft. Translation of the reels may be advantageous to selectively position modular frames along the length of a drive shaft. By way of example, reels may be translated to provide a spacing between adjacent modular frames to provide for an aisle for walking. The reels may be fixed into place after adjusting the location of the reels on a drive shaft.

The reels may include two walls. The two walls may be opposingly oriented. The walls may be disposed around the circumference of the reels. The walls may be generally parallel to one another. The walls may be angled in an opposing direction from one another. The angle may be different or generally equal. Angled walls may be spaced further away from each other around the outer perimeter of the reels relative to the spacing of walls toward the center of the reels. The angles may define ramps.

The walls may guide suspension members. The walls may ensure winding of suspension members within the confines of the reels. The walls may prevent suspension members from skipping off reels during winding.

The reels may include a generally cylindrical central portion. The generally cylindrical central portion may be co-linear with a rotational axis of the reels, drive shaft, motor, or any combination thereof. A suspension member may wind around the generally cylindrical portion. A suspension member may form one or more wound layers around the generally cylindrical portion.

One or more height adjustment assemblies may be employed with the system of the present disclosure. Two or more height adjustment assemblies may be located with drive shafts coaxial with one another, in parallel with one another, or both. Two or more height adjustment assemblies may cooperate in actuating multiple light assemblies that are affixed to each other.

The arrangement of multiple height adjustment assemblies may be selected to suit different spatial dimensions of rooms, different floor plans, or both. By way of example, a room may include two or more height adjustment assemblies with drive shafts in parallel with one another to locate above parallel rows of plants while providing walking aisles between the parallel rows of plants. By way of another example, a room may include two or more height adjustment assemblies with drive shafts coaxial with one another and a spacing between ends of adjacent height adjustment assemblies to accommodate an aisle for walking.

The height adjustment assembly may be mounted to a structure. The structure may include a building, stationary supports, movable supports, or any combination thereof.

The height adjustment assembly may be mounted via support elements (e.g., brackets, framing, and/or the like). The height adjustment assembly may be mounted by driving fasteners through one or more elements of the height adjustment assembly into one or more support elements and/or the structure. The motor may be mounted to the structure. One or more drive shafts may be mounted to the structure provided they are free to rotate. By way of example, one or both ends of a drive shaft may be located into a bracket having bearings. Both the motor and the drive shaft may be mounted to one or more structures.

The building may comprise one or more walls, ceilings, or both. The height adjustment assembly may be mounted to a ceiling, wall, or both. The height adjustment assembly may depend from one or more support elements. The one or more support elements may be affixed to a ceiling, wall, or both. The height adjustment assembly may depend from one or more cantilevered members. For example, the height adjustment assembly may be mounted to one or more brackets extending from a wall.

The height adjustment assembly may be mounted to one or more stationary supports. The stationary support may include one or more upright support members, horizontal support members, or both. The upright support members may engage the ground. For example, the height adjustment assembly may be supported on opposing ends by two posts resting on and/or fastened to the ground. Horizontal support members may extend from the upright support members. The height adjustment assembly may be affixed to the horizontal support members.

The height adjustment assembly may be supported by one or more movable supports. The movable supports may include one or more upright support members, horizontal support members, or both. The movable support may comprise one or more wheels, tracks, and/or the like.

The height adjustment assembly may comprise one or more suspension members. The suspension members may function to wind around a reel, connect a light assembly to a drive shaft, raise or lower light assemblies, or any combination thereof. The suspension member may selectively wind and unwind from a reel. The height adjustment assembly may be coupled to one or more light assemblies via one or more suspension members.

The position of the height adjustment assembly may be fixed. The position of the light assemblies may be movable relative to the height adjustment assembly. The position of the light assemblies may be movable via one or more suspension members.

The suspension members may wind around reels to move the light assemblies upward and closer to the height adjustment assembly. The suspension members may unwind from reels to move the light assemblies downward and further from the height adjustment assembly.

The suspension members may be coupled at a first end to the drive shaft, one or more reels, or both. The suspension members may be coupled at a second end to one or more light assemblies. Winding and unwinding of suspension members may cause a light assembly to move upward and downward, respectively.

The suspension members may wind around respective reels when a drive shaft rotates in a first angular direction. The suspension members may un-wind from respective reels when a drive shaft rotates in a second angular direction.

The suspension members may be selected from a cable, a wire, a rope, a fiber, a strap, a chain, or any combination thereof. The suspension members may be fabricated from synthetic fiber, natural fiber, metal, polymer, or any combination thereof.

The suspension member may have a diameter of about 2 mm or more, 5 mm or more, 10 mm or more, or even 15 mm or more. The suspension member may have a diameter of about 30 mm or less, 25 mm or less, or even 20 mm or less.

Each suspension member may be attached at one end to a modular frame. Where one suspension member is employed, the suspension member may be attached at or above a center of gravity of a modular frame. Where two or more suspension members are employed, the suspension members are attached on or above an axis extending through the center of gravity of a modular frame. By way of example, a modular frame with rectangular geometry may have an axis extending through the geometric center of the rectangular geometry (center of gravity) and extending through center points on opposing edges of the modular frame.

The height adjustment assembly may comprise one or more first suspension members attached at one end to a drive shaft and/or reel. The first suspension members may be attached at one end to two or more second suspension members, more preferably three or more second suspension members, or more preferably four or more second suspension members. A larger quantity of second suspension members may be advantageous to balance and stabilize a modular frame. By way of example, four of the second suspension members, branching off from one of the first suspension members, may each be coupled at one end to each of the four corners of a modular frame having rectangular geometry. The second suspension members may cooperate to balance the modular frame so that it remains generally parallel to the ground.

Two or more suspension members may be attached to a modular frame at points that are generally equidistant from an axis. The axis may extend through the center of gravity of a modular frame. The points may be located anywhere between an edge of a modular frame and an axis extending through the center of gravity of a modular frame. The points may be located on or adjacent to opposing edges of a modular frame. At least two points of attachment may be located on or adjacent to opposing corners of a modular frame.

One or more suspension members may extend directly between a drive shaft and/or reels and modular frames. One or more pulleys may cooperate with the suspension members. The suspension members may engage pulleys and then extend toward the modular frames.

Pulleys may function to horizontally displace the modular frames from the height adjustment assembly. That is, in the absence of pulleys the modular frames may depend straight down from the height adjustment assembly.

In some aspects, a first set of suspension members may depend straight down to the modular frame from a drive shaft and/or reels and a second set of suspension members may extend a distance horizontally to engage pulleys and then from the pulleys depend straight down to the modular frame. Pulleys may be located a distance from a height adjustment assembly, the distance being generally equal to the width of a modular frame. The distance may be greater than or less than the width of a modular frame. Suspension members extending directly between a drive shaft and/or reels and modular frames may be coupled to or adjacent to a first edge of the modular frame. Suspension members engaged with pulleys may be coupled to or adjacent to a second edge of the modular frame.

The height adjustment assembly may comprise one or more, two or more, or even three or more suspension members per modular frame. Suspension members may have different or equidistant spacing between adjacent suspension members.

The botanical lighting system may comprise one or more light assemblies. The light assembly may function to raise and lower according to the operation of the height adjustment assembly, retain one or more lights, or both.

The light assembly may depend from a height adjustment assembly, one or more pulleys, or both. The light assembly may depend via one or more suspension members.

The light assembly may comprise one or more modular frames, lights, or both.

The light assembly may comprise one or more modular frames. The modular frame may function to retain one or more lights. Lights may be removable, replaceable, or both.

The modular frames may be fabricated from rigid structures. The modular frames may be configured to be lightweight while being sturdy enough to support the weight of the lights.

The modular frame may be fabricated from polymer, metal, or both. The polymer may include polyethylene, polypropylene, polyvinylchloride, polyamide, polycarbonate, polymethylmethacrylate, or any combination thereof. The metal may include aluminum, magnesium, zinc, tin, brass, iron, steel, titanium, or any combination thereof. Aluminum may be particularly advantageous relative to other types of metals due to its rigidity, weight, and corrosion-resistance. The polymer or metal may be extruded.

The modular frames may be fabricated from T-slot extrusions. The T-slot extrusions may have a shaped cross-section. The shaped cross-section may be triangular, square, or any other polygonal shape. One or more sides of the extrusion may comprise a T-slot. The T-slot may extend the entire length of the extrusion, or at least a portion thereof. The T-slots may be advantageous for the modularity of the frames by providing a plurality of fastening points for fastening multiple modular light racks to each other and/or fastening light assemblies to the modular light racks.

The modular frames may have a polygonal geometry. By way of example, a modular frame may be fabricated from four T-slot extrusions arranged together with rectangular geometry.

One or more modular frames may fasten to one or more other modular frames. The quantity of modular frames fastened together may be selected for the area occupied by plants. By way of example, two modular frames with dimensions of 3 meters by 1 meter may be fastened together to form combined dimensions of 6 meters by 1 meter, in order to provide light to a row of plants extending 6 meters.

Modularity of the frames may be particularly advantageous to provide a single element that may be manufactured with standard dimensions, purchased in multiples, and configured together to suit a variety of end-use scenarios. This may reduce the overall manufacturing complexity and thus costs of the modular frames.

Various consumers may be constrained by different room dimensions where indoor growing is to take place. By way of example, the system of the present teachings may be configured to fit within both a 10-meter by 10-meter room and a 50-meter by 50-meter room by employing a different quantity of modular frames. Moreover, various floor layouts may be accommodated for with the modular frames. By way of example, a spacing between modular frames may be employed to accommodate an aisle for walking in between sections of plants.

Modular frames may fasten together edge-to-edge. One or more fasteners may fasten modular frames together. The fasteners may include screws, bolts, nails, rivets, snaps, ties, straps, the like, or any combination thereof.

The light assembly may comprise one or more lights. The lights may function to provide light radiation to plants. The lights may supplement for sunlight. The lights may provide light radiation in a photosynthetically active region of the electromagnetic spectrum, in an ultraviolet region of the electromagnetic spectrum, in a far-red region of the electromagnetic spectrum, or any combination thereof.

The lights may include light-emitting diode (“LED”), incandescent, compact fluorescent lamp, candelabra, halogen, fluorescent, the like, or any combination thereof.

The lights adapted for botanical applications are merely exemplary of the lights of the present disclosure. Other applications of the lights are within the scope of the present application.

The lights may be coupled to modular frames. The quantity and positions of lights disposed on modular frames may depend on the quantity of plants located under a modular frame, position of plants located under a modular frame, spacing of plants located under a modular frame, species of plant, or any combination thereof.

The quantity of lights employed may depend on the light intensity of each individual light. That is, fewer lights having a relatively greater intensity may be employed compared lights having a relatively lower intensity.

The botanical lighting system may comprise one or more sensors. The sensor may function to sense the position of a canopy, trigger raising and/or lowering of one or more light assemblies, or any combination thereof.

The sensor may cause a height adjustment assembly to raise one or more light assemblies. The sensor may detect when plants interfere with a sensor field. A height adjustment assembly may raise one or more light assemblies upon interference of a sensor field. The sensor may be in signal communication with one or more controllers, computing devices, or both. Upon interference of a sensor field, the sensor may send a signal to one or more controllers, computing devices, or both.

The sensor may emit electromagnetic radiation. A sensor field may refer to an area in which electromagnetic radiation is emitted by a sensor. Electromagnetic radiation may be absorbed, reflected, and/or deflected by objects intruding into the sensor field. Reflected radiation may be sensed by the sensors, indicating interference with a sensor field. The sensor may be a curtain sensor. The sensor may comprise an absorber module and an emitter module. Radiation emitted by the emitter module and not received by the absorber module may indicate interference with a sensor field.

The sensor field may be defined by the distance between an emitter module and an absorber module; the length of the emitter module and the absorber module along which radiation is emitted/absorbed; or both. The length and/or width of the sensor field may be about 1 foot or more, 2 feet or more, or even 4 feet or more. The length and/or width of the sensor field may be about 10 feet or less, 8 feet or less, or even 6 feet or less.

The sensor may be defined by a resolution. The resolution, at least with respect to curtain sensors, may mean the distance between individual beams of radiation emitting from the emitter module. The sensor may have a resolution of about 24 mm or less, 22 mm or less, 20 mm or less, 16 mm or less, 14 mm or less, or even 12 mm or less. Plants or portions thereof (e.g., leaves) may not be detected by sensors having a resolution greater than 14 mm.

The sensor may include ultrasonic motion sensors, microwave motion sensors, tomographic motion sensors, photo sensors, infrared motion sensors, or any combination thereof.

The sensor may be coupled to a modular frame. The sensor may be height-adjustable and/or horizontally adjustable relative to a light assembly. Height adjustment of a sensor may cause the sensor field to be located closer to or further from one or more lights. The distance between lights and plants may be adjusted by height adjusting the sensors. Horizontal adjustment of a sensor may cause the sensor field to be located relative to one or more plants. By way of example, a sensor field may be located generally above and in-line with the upward growing direction of plants.

The sensor may be mounted a distance from the lights. As triggering the sensors may cause the lights to move away from the plants, the distance between the sensors and the lights may define the minimum distance the canopy of the plants may be located from the lights.

The botanical lighting system may comprise one or more controllers. The controller may function to receive signals from sensors, send instructions in the form of signals to a motor, or both.

The controller may operate under one or more settings. The settings may include travel distance upon sensor trigger, time delay, height limit, or any combination thereof.

The controller may be coupled to the height-adjustable botanical lighting system. The controller may be located remote from the height-adjustable botanical lighting system. The controller may be coupled to a height adjustment assembly. The controller may be coupled to one or more light assemblies.

The controller may be in signal communication with one or more sensors, motors, lights, or any combination thereof. The controller may optionally be in signal communication with a switching device and/or one or more computing devices.

The switching device may function to receive tactile inputs from users and send instructions in the form of signals to a motor. The switching device may include one or more buttons, switches, dials, the like, or any combination thereof. At least one button, switch, dial, or the like may be actuated to cause the raising of light assemblies. At least one button, switch, dial, or the like may be actuated to cause the lowering of light assemblies. The switching device may be employed to manually height adjust the light assemblies.

The computing device may function to receive inputs from users and send instructions in the form of signals to a controller and/or motor. The computing device may include a mobile phone, a smartwatch, a tablet, a laptop computer, a desktop computer, the like, or any combination thereof. The computing device may be employed to control and/or monitor the operation of the botanical lighting system.

The computing device may direct the height adjustment of light assemblies. The computing device may receive inputs from a user, the inputs directing the raising and/or lowering of light assemblies. The inputs may be converted into signals. The signals may be received by a controller and/or motor. The signal may cause the actuation of a motor. By way of example, a user may manually adjust the height of a lighting assembly via a mobile phone. In this manner, a user need not be on-site to control and/or monitor operation of the botanical lighting system.

The computing device may be employed to control one or more settings of the controller.

The controller may be in signal communication with one or more sensors via a wired or wireless connection. The controller may be in signal communication with a motor via a wired or wireless connection. The computing device, switching device, or both may be in communication with a controller via a wired or wireless connection. The computing device, switching device, or both may be in communication with a motor via a wired or wireless connection. The wireless connection may employ a protocol including Wi-Fi, Bluetooth®, or both.

The controller may operate via one or more relays. A relay may operate the time delay. A relay may operate the rotational direction (e.g., clockwise or counterclockwise) of the motor. A relay may operate an autonomous mode, a manual mode, an on mode, an off mode, or any combination thereof.

The sensor, controller, switching device, computing device, or any combination thereof may include one or more network modules. The network module may function to receive and transmit signals via a wired and/or wireless network. One or more network modules may communicate with one or more other network modules via one or more networks. The network module may provide communication between sensors, controllers, switching devices, computing devices, or any combination thereof.

A wired network module may be any module capable of transmitting and/or receiving signals via a wired connection. The wired network module may include a network interface controller, PC Card, PCMCIA card, PCI card, the like, or any combination thereof. The wired connection may include an ethernet port. The wireless network module may include any module capable of transmitting and/or receiving signals via a wireless connection. The wireless network module may include a cellular transceiver, Wi-Fi transceiver, Bluetooth® transceiver, infrared transceiver, radio frequency transceiver, near-field communication module, the like, or any combination thereof.

Signals may be communicated over one or more networks. The network may include one or more local area networks, wide area networks, virtual private networks, cellular networks, intranet, internet, the like, or any combination thereof.

The method may comprise one or more of the following steps. It is understood that any of the method steps can be performed in virtually any order. Some of the steps may be duplicated, removed, rearranged relative to other steps, combined into one or more steps, separated into two or more steps, or a combination thereof.

Any of the following steps may be performed autonomously. Autonomous, as referred to herein, may mean without any human interaction, input, or direction. By way of example, the light assembly may continuously height adjust autonomously throughout the life cycle of the plants without any human interaction with the system.

The present disclosure provides for a method of operating a height-adjustable botanical lighting system. The method may comprise detecting, by a sensor, interference of a sensor field of the sensor. The sensor field may be interfered with by one or more generally upward advancing plants.

The method may comprise relaying, by the sensor, a signal to one or more controllers. The signal may indicate interference of the sensor field.

The method may comprise directing, by the controller, a motor to operate for a pre-determined amount of time or rotate a pre-determined number of rotations and/or fractions thereof. The directing of the motor may occur upon interference of the sensor field. The directing of the motor may occur after a time delay triggered upon interference of the sensor field.

A time delay may be employed. The time delay may function to prevent pulsing of the motor. After the time delay, operation of the motor may proceed automatically, or a confirmation signal may be sought. The confirmation signal may be generated by a repeated instance of sensor field interference. Pulsing of the motor may occur due to movement of plants. Plant stems may not be entirely rigid. Plant stems may bend under the weight of the flowers, leaves, or otherwise which they support. Environmental factors such as air flow or contact by persons may cause plants to move and/or sway. Plants influenced by these environmental factors may move and/or sway such that the canopy thereof may only briefly interfere with the sensor field. Thus, by the time delay, inadvertent operation of the motor may be avoided.

The time delay may be for about 0.1 seconds or more, 0.5 seconds or more, or even 1 second or more. The time delay may be for about 20 seconds or less, 10 seconds or less, or even 5 seconds or less.

Operation of the motor may cause one or more light assemblies to raise relative to the one or more generally upward advancing plants.

A height limit may be set. The height limit may preclude over-travel of the one or more light assemblies. That is, at a certain height, the one or more light assemblies may contact one or more reels, drive shafts, or otherwise. Continued actuation of the one or more light assemblies after coming into engagement with one or more reels, drive shafts, or otherwise may cause damage to the same and/or the one or more light assemblies.

The height limit may be defined by the rotational position of the motor and/or the drive shaft. That is, with a known length of suspension members and rotational position of the motor and/or the drive shaft, the distance between one or more light assemblies and the height adjustment assembly may be known.

The method may comprise receiving, by a controller, a signal. The signal may comprise instructions to operate a motor. The motor may cause the raising or lowering of light assemblies. The signal may be transmitted to the controller by a computing device, a switching device, or both. The signal may be input into a computing device, a switching device, or both by a user. The signal may be communicated over a network. The network may be a wireless and/or wired network.

The method may comprise receiving, by a controller, a height parameter. The height parameter may determine the pre-determined amount of time or the pre-determined number of rotations and/or fractions thereof of the motor. The height parameter may determine the distance a light assembly is adjusted upon interference of a sensor field by plants. The height parameter may be input into a controller by a user. The height parameter may be pre-determined. The height parameter may be adjustable. The height parameter may be adjusted during the life cycle of the plants. The height parameter may be selected based upon the growing stage of plants, the species of plants, environmental parameters the plants are exposed to, the type of light employed, or any combination thereof.

The method may comprise adjusting, by a controller, a height parameter by a constant. The adjustment may be performed at one or more points in time. The adjustment may be performed during the life cycle of plants. The constant may direct an adjustment of the distance between a canopy and light assembly. By way of example, during the first two weeks of growing, the distance may be about 1 foot and during the following two weeks of growing, the distance may be about 2 feet.

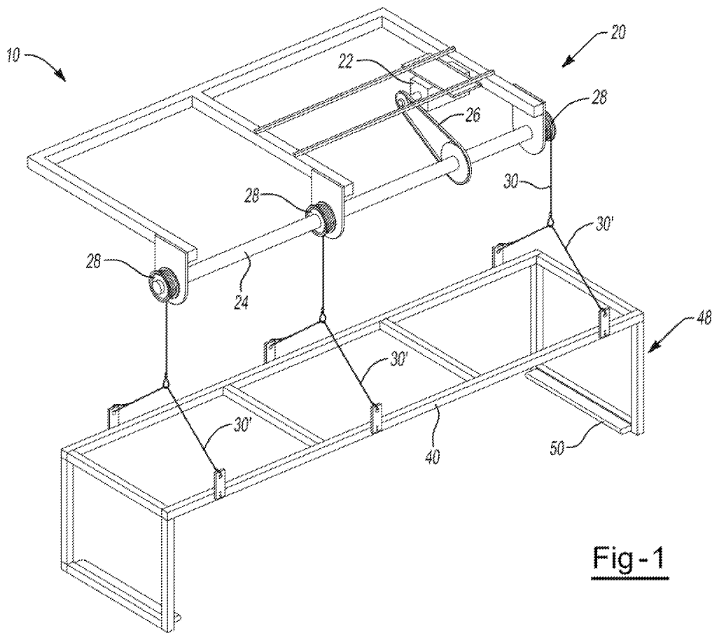

FIG. 1 is a perspective view of a height-adjustable botanical lighting system 10. The height-adjustable botanical lighting system 10 comprises a light assembly 40 suspended from a height adjustment assembly 20. The height adjustment assembly 20 comprises a drive shaft 24 caused to rotate by a motor 22. Rotational force is transferred from the motor 22 to the drive shaft 24 by the torque transfer member 26. The drive shaft 24 includes three reels 28 disposed along its length. Torque transferred from the motor 22 to the drive shaft 24 cause the reels 28 to rotate and selectively wind or un-wind suspension members 30. One end of the suspension members 30 is coupled to the reels 28 and the other end is coupled to other suspension members 30′ that diverge in orientation and couple to opposing edges of the light assembly 40. Two sets of reels 28, suspension members 30, and other suspension members 30′ are coupled to opposing edges of the light assembly 40 and another set of reel 28, suspension member 30, and other suspension members 30′ is coupled to a generally center portion of the light assembly 40. As a result, the light assembly 40 is balanced and equally supported, along its length, by the height adjustment assembly.

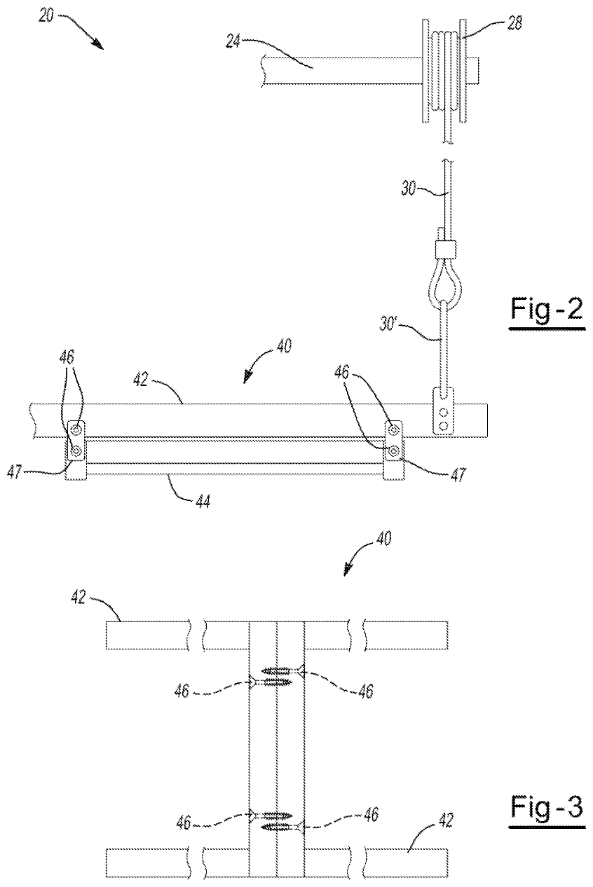

FIG. 2 is a plan view of a height-adjustable botanical lighting system 10. The height-adjustable botanical lighting system 10 comprises a light assembly 40 suspended from a height adjustment assembly 20. The height adjustment assembly 20 comprises a drive shaft 24 and reels 28, one of which is shown, located on the drive shaft 24. Torque transferred from the motor 22 to the drive shaft 24 cause the reels 28 to rotate and selectively wind or un-wind suspension members 30. One end of a suspension member 30 is coupled to a reel 28 and the other end of the suspension member 30 is coupled to other suspension members 30′ that diverge in orientation and couple to opposing edges of the light assembly 40.

The light assembly 40 comprises a light 44 coupled to a modular frame 42. The light assembly 40 is suspended from the modular frame 42 by a plate 47 being affixed to both the light 44 and the modular frame 42 by fasteners 46. The plate 47 is removable so the number and position of lights 44 on the modular frame 42 may be tailored to different use situations.

FIG. 3 is a plan view of a light assembly 40. The light assembly 40 comprises two modular frames 42. The two modular frames 42 are coupled together, edge-to-edge. The edges of the two modular frames 42 are affixed by fasteners 46.

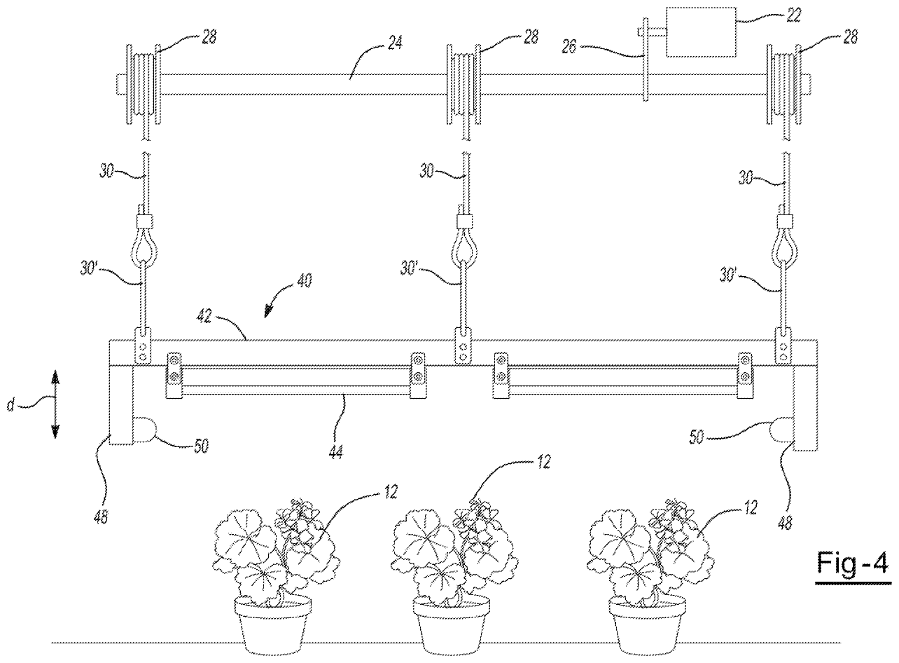

FIG. 4 is a plan view of a height-adjustable botanical lighting system 10. The height-adjustable botanical lighting system 10 comprises a light assembly 40 suspended from a height adjustment assembly 20. The light assembly 40 is suspended over plants 12. The height adjustment assembly 20 comprises a drive shaft 24 caused to rotate by a motor 22. Rotational force is transferred from the motor 22 to the drive shaft 24 by the torque transfer member 26. The drive shaft 24 includes three reels 28 disposed along its length. Torque transferred from the motor 22 to the drive shaft 24 cause the reels 28 to rotate and selectively wind or un-wind suspension members 30. One end of the suspension members 30 is coupled to the reels 28 and the other end is coupled to other suspension members 30′ that diverge in orientation and couple to opposing edges of the light assembly 40.

Two sensor adjustment members 48 are located on opposing edges of the light assembly 40. The sensor adjustment members 48 are coupled to the modular frame 42. A sensor 50 is located proximate to one end of each sensor adjustment member 48. A distance of the sensors 50 to the light 44 is adjustable by translating the sensor adjustment members 48 relative to the modular frame 42.

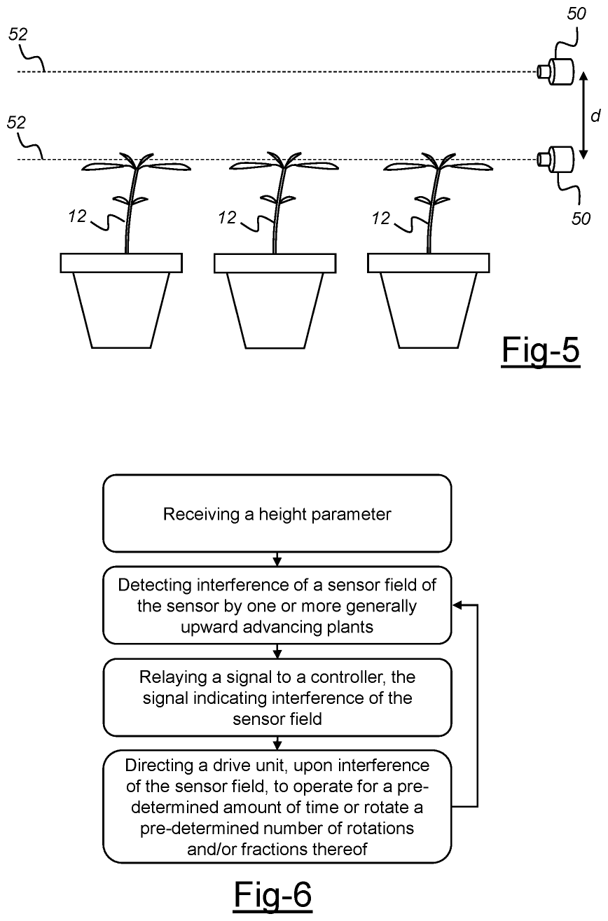

FIG. 5 illustrates operation of a sensor 50. The sensor 50 projects a sensor field 52. Plants 12 are located below the sensor field 52. As the plants 12 advance generally upward, they interfere with the sensor field 52. In response, the sensor 50 raises by a distance d. The plants 12 continue to advance generally upward and every time the canopy of the plants 12 interfere with the sensor field 52, the sensor 50 continues to raise by a distance d.

FIG. 6 illustrates a flowchart of a method of operating a height-adjustable botanical lighting system.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled.

Other combinations are also possible as will be gleaned from the following claims, which are also hereby incorporated by reference into this written description. The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### REFERENCE NUMERALS

10 Height-adjustable botanical lighting system
12 Plant
20 Height adjustment assembly
22 Motor
24 Drive shaft
26 Torque transfer member
28 Reel
30 Suspension member
40 Light assembly
42 Modular frame
44 Light
46 Fastener
50 Sensor
52 Sensor field
54 Controller
56 Switching device
58 Computing device

What is claimed is:

1. A height-adjustable botanical lighting system comprising:
a height adjustment assembly,
one or more light assemblies depending from the height adjustment assembly, and
one or more sensors adjustably coupled to the one or more light assemblies;
wherein the one or more sensors autonomously cause the height adjustment assembly to raise the one or more light assemblies in response to one or more generally upward advancing plants interfering with a sensor field of the one or more sensors.

2. The height-adjustable botanical lighting system according to claim 1, wherein the one or more sensors are height-adjustable and/or horizontally adjustable relative to the one or more light assemblies;
wherein height adjustment of the one or more sensors causes the sensor field to be located closer to or further from the one or more light assemblies; and
wherein horizontal adjustment of the one or more sensors causes the sensor field to be located relative to generally upwardly advancing growth paths the one or more plants.

3. The height-adjustable botanical lighting system according to claim 2, wherein the height-adjustable botanical lighting system comprises a controller in signal communication with both the one or more sensors and the height adjustment assembly,
wherein the controller is optionally in signal communication with a switching device and/or a computing device.

4. The height-adjustable botanical lighting system according to claim 3, wherein the computing device is a mobile computing device.

5. The height-adjustable botanical lighting system according to claim 1, wherein the one or more light assemblies comprise:
one or more modular frames, and
one or more lights coupled to the one or more modular frames.

6. The height-adjustable botanical lighting system according to claim 5, wherein each of the one or more modular frames couple together edge-to-edge.

7. The height-adjustable botanical lighting system according to claim 1, wherein the height adjustment assembly comprises:
a motor;
a drive shaft in direct or indirect communication with the motor;
optionally a torque transfer member for transferring a torque of the motor, that is in indirect communication with the drive shaft, to the drive shaft;
one or more reels coupled to the drive shaft; and
one or more suspension members adapted to selectively wind and unwind from the one or more reels;
wherein the one or more light assemblies depend from the height adjustment assembly by the one or more suspension members.

8. The height-adjustable botanical lighting system according to claim 7, wherein the one or more suspension members include at least two suspension members coupled to or adjacent to opposing edges of each of the one or more light assemblies.

9. The height-adjustable botanical lighting system according to claim 7, wherein each of the one or more suspension members are attached at one end to two or more other suspension members, the two or more other suspension members being coupled to or adjacent to opposing edges of each of the one or more light assemblies.

10. The height-adjustable botanical lighting system according to claim 7, wherein the torque transfer member is selected from a roller chain or a belt.

11. The height-adjustable botanical lighting system according to claim 10, wherein the torque transfer member is the roller chain, and the drive shaft includes a sprocket that engages with the roller chain.

12. The height-adjustable botanical lighting system according to claim 10, wherein the torque transfer member is the belt, and the drive shaft includes a belt pulley that engages with the belt.

13. The height-adjustable botanical lighting system according to claim 7, wherein the one or more suspension members are selected from a cable, a wire, a rope, a strap, or a chain.

14. The height-adjustable botanical lighting system according to claim 7, wherein the motor is a stepper motor or a servo motor.

15. A method of operating a height-adjustable botanical lighting system, the method comprising:
detecting, by a sensor, interference of a sensor field of the sensor by one or more generally upward advancing plants;
relaying, by the sensor, a signal to a controller, the signal indicating interference of the sensor field; and
directing, by the controller, a motor, upon interference of the sensor field, to operate for a pre-determined amount of time or rotate a pre-determined number of rotations and/or fractions thereof;
wherein operation of the motor causes one or more light assemblies to raise relative to the one or more generally upward advancing plants.

16. The method according to claim 15, wherein the method comprises receiving, by the controller, a height parameter;
wherein the height parameter determines the pre-determined amount of time or the pre-determined number of rotations and/or fractions thereof for which the motor operates.

17. The method according to claim 16, wherein the method comprises adjusting, by the controller, the height parameter by one or more constants at one or more points in time.

18. The method according to claim 15, wherein the height-adjustable botanical lighting system is the height-adjustable botanical lighting system according to claim 1.

19. The height-adjustable botanical lighting system according to claim 1, wherein the one or more sensors are curtain sensors.

20. The height-adjustable botanical lighting system according to claim 19, wherein the one or more sensors are mounted about 3 feet or less from one or more lights affixed to the one or more light assemblies.
